(19) United States
(12) Patent Application Publication
(10) Pub. No.: US 2023/0080784 A1
(43) Pub. Date: Mar. 16, 2023

(54) ROADSIDE RELAY APPARATUS, CENTRAL APPARATUS, AND METHOD FOR PROVIDING SIGNAL INFORMATION

(71) Applicant: SUMITOMO ELECTRIC INDUSTRIES, LTD., Osaka-shi, Osaka (JP)

(72) Inventors: Toji OKAYAMA, Osaka-shi (JP); Hiroyuki ISHIMARU, Osaka-shi (JP)

(73) Assignee: SUMITOMO ELECTRIC INDUSTRIES, LTD., Osaka-shi, Osaka (JP)

(21) Appl. No.: 17/792,597

(22) PCT Filed: Nov. 2, 2020
(86) PCT No.: PCT/JP2020/041047

§ 371 Date: Jul. 13, 2022

(30) Foreign Application Priority Data
Jan. 30, 2020 (JP) 2020-013686

(51) Int. Cl. G08G 1/095

(52) U.S. Cl. CPC G08G 1/095

(57) ABSTRACT

A roadside relay apparatus includes first, second, and third communication units to which first, second, and third lines described below are connected, a communication processing unit configured to relay or intercept communication between the first and second communication units, and an information processing unit configured to generate signal information for a vehicle, based on a control command, for controlling a traffic signal controller, received by the first communication unit and based on details of control, performed by the traffic signal controller, received by the second communication unit, and to output the generated signal information to the third communication unit. The first, second, and third lines are communication lines for wired communication with a central apparatus of a traffic control system, the traffic signal controller, and a communication apparatus that belongs to a communication system configured to wirelessly provide information to the vehicle, respectively.

### TECHNICAL FIELD

The present disclosure relates to a roadside relay apparatus, a central apparatus, and a method for providing signal information.

This application claims priority based on Japanese Patent Application No. 2020 013686 filed on Jan. 30, 2020, the entire contents of which are incorporated herein by reference.

### BACKGROUND ART

Patent Literature 1 (PTL 1) describes a communication system including a central apparatus of a traffic control center, a traffic signal controller connected to the central apparatus via a predetermined communication line, a roadside communication device connected to the traffic signal controller via a predetermined communication line, and an on-vehicle communication device wirelessly communicating with the roadside communication device.

In a conventional communication system, a traffic signal controller generates signal information for a vehicle including a scheduled display time of a signal light color. The traffic signal controller transmits the generated signal information to the roadside communication device, and the roadside communication device wirelessly transmits the received signal information to the on-vehicle communication device.

### CITATION LIST

### Patent Literature

PTL 1: Japanese Patent Application Laid-Open No. 2010-146133

### SUMMARY OF INVENTION

An apparatus (roadside relay apparatus) according to an aspect of the present disclosure includes a first communication unit to which a first line described below is connected, a second communication unit to which a second line described below is connected, a third communication unit to which a third line described below is connected, a communication processing unit configured to relay or intercept communication between the first communication unit and the second communication unit, and an information processing unit configured to generate signal information for a vehicle, based on a control command, for controlling a traffic signal controller, received by the first communication unit and based on details of control, performed by the traffic signal controller, received by the second communication unit, and to output the generated signal information to the third communication unit.

The first line is a communication line for wired communication with a central apparatus of a traffic control system.

The second line is a communication line for wired communication with the traffic signal controller.

The third line is a communication line for wired communication with a communication apparatus that belongs to a communication system configured to wirelessly provide information to the vehicle.

An apparatus (a central apparatus) according to another aspect of the present disclosure is a central apparatus configured to communicate with the roadside relay apparatus described above that includes a communication unit configured to receive an abnormality notification for notifying an abnormality of a communication device from the roadside relay apparatus, a storage unit configured to store a management table including a type of the communication device in which the abnormality has occurred, details of the abnormality, and a service provider operating the communication device in which the abnormality has occurred as items to be managed, and a control unit configured to record the details of the abnormality and the service provider in the management table for each type of the communication device corresponding to identification information of the communication device.

A providing method according to an aspect of the present disclosure is a method for providing signal information performed by a roadside relay apparatus including a first communication unit to which the first line is connected, a second communication unit to which the second line is connected, a third communication unit to which the third line is connected, and a communication processing unit configured to relay or intercept communication between the first communication unit and the second communication unit. The method includes a step of generating signal information for a vehicle, based on a control command, for controlling a traffic signal controller, received by the first communication unit and based on details of control, performed by the traffic signal controller, received by the second communication unit, and a step of outputting the generated signal information to the third communication unit.

The present disclosure can be implemented not only as a system and an apparatus including the above-described characteristic configuration but also as a program for causing a computer to execute the characteristic configuration. The present disclosure can be implemented as a semiconductor integrated circuit that implements a part or all of a system and an apparatus.

### BRIEF DESCRIPTION OF DRAWINGS

FIG. 1 is a block diagram illustrating an example of an overall configuration of a traffic control system.

FIG. 2 is a road plan view illustrating an example of a roadside apparatus around an intersection.

FIG. 3 is a road plan view illustrating another example of a roadside apparatus around an intersection.

FIG. 4 is a block diagram illustrating an example of an internal configuration of a central apparatus 6.

FIG. 5 is a block diagram illustrating an example of an internal configuration of a traffic signal controller 12.

FIG. 6A is a schematic diagram illustrating an example of a connection configuration between an old controller and another communication node.

FIG. 6B is a schematic diagram illustrating an example of a connection configuration between a new controller and another communication node.

FIG. 7 is a schematic diagram illustrating an example of a connection configuration between a roadside relay apparatus and another communication node.

FIG. 8 is a block diagram illustrating an example of an internal configuration of a roadside relay apparatus.

FIG. 9 is a diagram illustrating an example of a format of a signal control command.

FIG. 10 is a diagram illustrating an example of a format of signal operation state information.

FIG. 11 is a table illustrating an example of a signal control plan created by a roadside relay apparatus.

FIG. 12A is a diagram illustrating a data structure of a signal information.

FIG. 12B is an explanatory diagram illustrating data values and details of data stored in a header section and a data section of signal information.

FIG. 13 is a schematic diagram illustrating an example of an overall configuration of an abnormality monitoring system.

FIG. 14 is a block diagram illustrating another example of an internal configuration of a roadside relay apparatus.

### DETAILED DESCRIPTION

### Problems to be Solved by Present Disclosure

In order to connect a roadside communication device to a traffic signal controller via a predetermined communication line, the traffic signal controller needs to have a communication interface corresponding to the communication line. However, an existing traffic signal controller is often an older model that has no communication interface for a roadside communication device.

Therefore, in order to construct a communication system that can provide signal information for a vehicle at an intersection where an old traffic signal controller is installed, it is necessary to replace or modify the traffic signal controller with a new traffic signal controller having the communication interface for the roadside communication device, which is a costly problem.

An object of the present disclosure is to provide signal information for a vehicle to the vehicle without replacing or modifying an existing traffic signal controller.

### Advantageous Effects of Present Disclosure

According to the present disclosure, signal information for a vehicle can be provided to the vehicle without replacing or modifying an existing traffic signal controller.

### Description of Embodiments of Present Disclosure

Hereinafter, contents of embodiments according to the present disclosure will be listed and described.

(1) A roadside relay apparatus according to the present embodiment includes a first communication unit to which a first line described below is connected, a second communication unit to which a second line described below is connected, a third communication unit to which a third line described below is connected, a communication processing unit configured to relay or intercept communication between the first communication unit and the second communication unit, and an information processing unit configured to generate signal information for a vehicle, based on a control command, for controlling a traffic signal controller, received by the first communication unit and based on details of control, performed by the traffic signal controller, received by the second communication unit, and to output the generated signal information to the third communication unit.

The first line is a communication line for wired communication with a central apparatus of a traffic control system.

The second line is a communication line for wired communication with the traffic signal controller.

The third line is a communication line for wired communication with a communication apparatus that belongs to a communication system configured to wirelessly provide information to the vehicle.

According to the roadside relay apparatus of the present embodiment, the information processing unit generates the signal information for the vehicle, based on the control command, for controlling the traffic signal controller, received by the first communication unit and based on the details of control, performed by the traffic signal controller, received by the second communication unit, and outputs the generated signal information to the third communication unit. Accordingly, even if the traffic signal controller does not support the third line, the signal information can be transmitted to the communication apparatus that belongs to the communication system configured to wirelessly provide information to the vehicle. Therefore, the signal information for a vehicle can be provided to the vehicle without replacing or modifying the existing traffic signal controller.

(2) In the roadside relay apparatus according to the present embodiment, it is preferable that the second communication unit is configured to receive executed step information transmitted by the traffic signal controller at a time of a step change, and the information processing unit is configured to correct a duration of a step in a signal control plan required in generation of the signal information, based on a reception timing of the executed step information.

According to the roadside relay apparatus of the present embodiment, since the information processing unit corrects the duration of the step in the signal control plan required in generation of the signal information based on the reception timing of the executed step information, it is possible to improve an accuracy of the signal information for a vehicle as compared to a case where no correction is made.

(3) In the roadside relay apparatus according to the present embodiment, it is preferable that the roadside relay apparatus further includes a light-color monitoring unit configured to monitor a current light color of a signal light unit coupled to the traffic signal controller, and the information processing unit is configured to correct a duration of a step in a signal control plan required in generation of the signal information, based on a change timing of the current light color.

According to the roadside relay apparatus of the present embodiment, since the information processing unit corrects the duration of the step in the signal control plan required in generation of the signal information based on the change timing of the current light color, it is possible to improve an accuracy of the signal information for a vehicle as compared to a case where no correction is made.

(4) In the roadside relay apparatus according to the present embodiment, it is preferable that the roadside relay apparatus further includes a light-color monitoring unit configured to monitor a current light color of a signal light unit coupled to the traffic signal controller, and the information processing unit is configured to determine whether or not there is an abnormality in the traffic signal controller, based on a transition state of the current light color.

According to the roadside relay apparatus of the present embodiment, since the information processing unit determines whether or not there is an abnormality in the traffic signal controller, based on the transition state of the current light color, it is possible to accurately determine whether or not there is an abnormality in the traffic signal controller.

(5) In the roadside relay apparatus according to the present embodiment, it is preferable that the information processing unit is configured to in a case of detecting an abnormality in at least one of a communication device that is the roadside relay apparatus, a communication device configured to communicate with the second communication unit, or a communication device configured to communicate with the third communication unit, generate an abnormality notification that includes details of the abnormality and identification information of the communication device in which the abnormality has occurred and that is directed to the central apparatus, and output the generated abnormality notification to the communication processing unit.

According to the roadside relay apparatus of the present embodiment, since the information processing unit generates the abnormality notification that includes the details of the abnormality and the identification information of the communication device in which the abnormality has occurred and that is directed to the central apparatus, and outputs the generated abnormality notification to the communication processing unit, the details of the abnormality and the identification information of the communication device in which the abnormality has occurred can be notified to the central apparatus.

(6) In the roadside relay apparatus of the present embodiment, the information processing unit is configured to include an occurrence period of the abnormality in the abnormality notification. In this manner, the occurrence period of the abnormality can be also notified to the central apparatus.

(7) In the roadside relay apparatus according to the present embodiment, it is preferable that the information processing unit is configured to stop outputting the signal information, in the case of detecting the abnormality.

This is because incorrect signal information may be provided when there is an abnormality in a communication device related to provision of signal information.

(8) A central apparatus according to the present embodiment is a central apparatus configured to communicate with the roadside relay apparatus described above that includes a communication unit configured to receive the abnormality notification, a storage unit configured to store a management table including a device, details, and a service provider as items to be managed, and a control unit is configured to manage the management table. The control unit is configured to record, as the item of the device, a type of a communication device corresponding to the identification information included in the received abnormality notification, record, as the item of the details, the details of the abnormality included in the received abnormality notification, and record, as the item of the service provider, a type of a service provider corresponding to the identification information included in the received abnormality notification.

According to the central apparatus of the present embodiment, since the control unit performs the above-described recording as each item of the management table, a management table that can determine the details of the abnormality and the type of the service provider operating the communication device is automatically created for each type of the communication device in which the abnormality has occurred.

Accordingly, a user of the central apparatus (for example, an operator of the traffic control center) can quickly perform a response such as reporting the fact and the details of the abnormality occurrence.

(9) In the central apparatus of the present embodiment, it is preferable that the abnormality notification further includes an occurrence period of the abnormality, the items to be managed in the management table further includes an occurrence period, and the control unit is configured to record, as the item of the occurrence period, the occurrence period of the abnormality included in the received abnormality notification.

Due to this, it is possible to evaluate each of service providers related to the provision of signal information by aggregating the occurrence period of the abnormality for each type of service providers.

(10) A providing method of the present embodiment relates to a method of providing signal information performed by the roadside relay apparatus according to any one of (1) to (7) described above. Therefore, the providing method of the present embodiment has the same effects as those of the roadside relay apparatus of (1) to (7) described above.

### Details of Embodiments of Present Disclosure

Hereinafter, embodiments of the present disclosure will be described in detail with reference to the drawings. Note that at least some of the embodiments described below may be arbitrarily combined.

### [Overall Configuration of Traffic Control System]

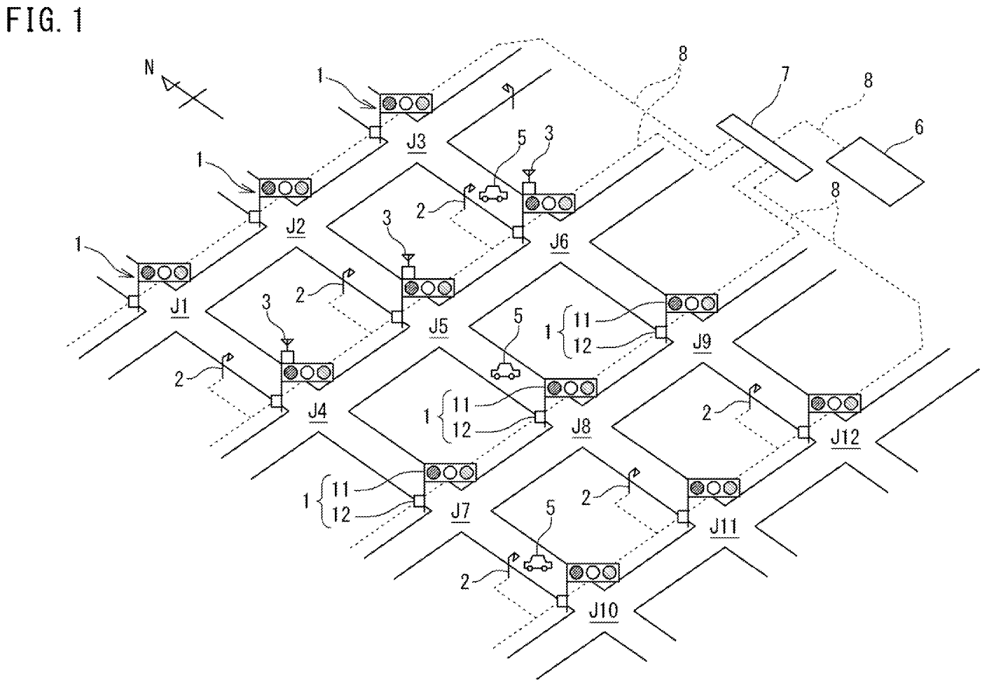

FIG. 1 is a perspective view illustrating an overall configuration of a traffic control system according to the present embodiment.

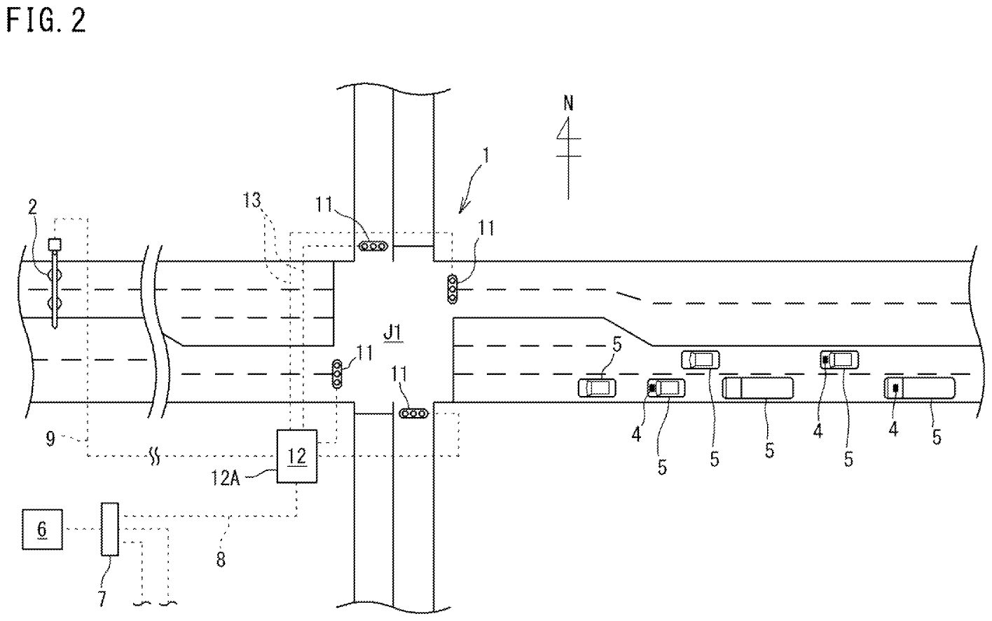

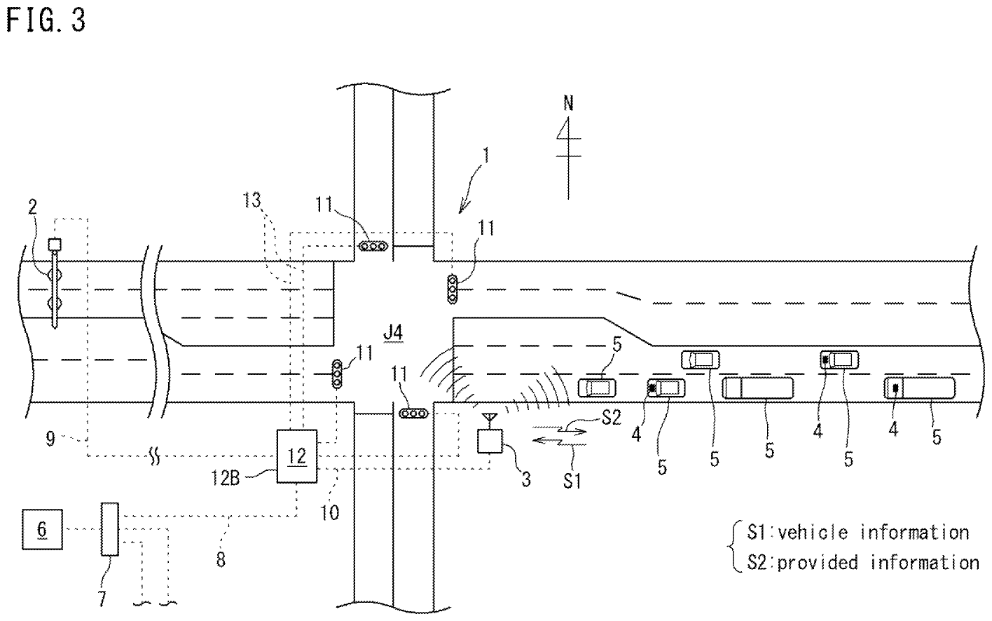

FIG. 1 illustrates, as an example, a traffic control system in a case where communication between a central apparatus 6 and a traffic signal controller 12 is IP communication. As illustrated in FIG. 1, the traffic control system of the present embodiment includes a traffic signal device 1, a roadside sensor 2, a roadside communication device 3, a vehicle 5 on which an on-vehicle communication device 4 (see FIGS. 2 and 3) is mounted, central apparatus 6, and the like. Vehicle 5 includes a vehicle having on-vehicle communication device 4 that can communicate with roadside communication device 3, and a vehicle having no on-vehicle communication device 4.

Traffic signal device 1 includes a plurality of signal light units 11 (only one signal light unit is illustrated in FIG. 1) for indicating whether or not there is a right of way for each inflow road of an intersection, and traffic signal controller 12 that control timings of turning-on and turning-off of round lights, arrow lights, and the like included in signal light units 11.

Traffic signal controller 12 is installed at each of a plurality of intersections Ji (i=1 to 12 in the illustrated example) included in a jurisdiction area of central apparatus 6. Traffic signal controller 12 is connected to a router 7 via a dedicated communication line 8 such as a telephone line.

Router 7 is connected to central apparatus 6 of a traffic control center via communication line 8. Central apparatus 6 forms a LAN (Local Area Network) with traffic signal controller 12 of each of intersections Ji included in the jurisdiction area of the central apparatus

Therefore, central apparatus 6 can communicate with traffic signal controller 12 in the jurisdiction area, and traffic signal controller 12 can also communicate with traffic signal controllers 12 of other intersections Ji. Central apparatus 6 may be installed on a road or on a roadside instead of the traffic control center.

Roadside sensor 2 is installed at an appropriate position on a road in the jurisdiction area primarily for the purpose of counting the number of vehicles entering each of intersections Ji.

Roadside sensor 2 includes at least one of a vehicle sensor that detects vehicle 5 passing directly below by ultrasonic waves or the like, a loop coil that detects vehicle 5 by a change in inductance, a monitoring camera that photographs a traffic state of vehicle 5 in time series, or an optical beacon that performs optical communication with vehicle 5 by near infrared rays. Roadside sensor 2 may be a sensor using a radio wave such as a millimeter wave, or a Lidar sensor.

Roadside communication device 3 includes a roadside wireless communication device that supports, for example, ITS (Intelligent Transport Systems) wireless communication. Roadside communication devices 3 are installed near one or more intersections Ji included in the jurisdiction area of central apparatus 6.

In an example of FIG. 1, roadside communication devices 3 are installed at some intersections J4 to J6 such as important intersections among intersections J1 to J12 included in the jurisdiction area, and roadside communication devices 3 are not installed at the other intersections J1 to J3 and J7 to J12.

Roadside communication device 3 can receive a communication frame of inter-vehicle communication wirelessly performed by on-vehicle communication device 4 of vehicle 5 passing on a road, and can wirelessly transmit a communication frame including a provided information for a vehicle to on-vehicle communication device 4.

Roadside sensor 2 is connected to traffic signal controller 12 via a dedicated communication line 9 (see FIGS. 2 and 3). Roadside communication device 3 is connected to traffic signal controller 12 via a communication line 10 different from communication line 9 (see FIG. 3).

On-vehicle communication device 4 is a vehicle-side wireless communication device that supports ITS wireless communication. Therefore, on-vehicle communication device 4 can perform wireless communication (vehicle-to-vehicle communication) with another vehicle 5 traveling on the road, and can also receive the communication frame including the provided information for a vehicle that is downlink-transmitted by roadside communication device 3.

On-vehicle communication device 4 may have an optical communication function of performing optical communication using near infrared rays with the optical beacon in a communication area below the optical beacon.

Central apparatus 6 includes one or more server computers owned by a service provider responsible for traffic control. Central apparatus 6 collects sensor information measured by roadside sensor 2, inter-vehicle communication information (hereinafter also referred to as “vehicle information”) received by roadside communication device 3 from vehicle 5, and the like.

The sensor information includes detected information (traffic volume and occupancy time) by the vehicle sensor, beacon information in which the optical beacon is received from on-vehicle communication device 4 compatible with optical communication, and the like. The inter-vehicle communication information includes a vehicle ID, a time, a position, a speed, and the like of vehicle 5 that generated the information.

Central apparatus 6 calculates a traffic index such as an incoming traffic volume per unit time to intersection Ji by using various collected data. Central apparatus 6 performs traffic-sensing control (centralized control) for intersection Ji belonging to the jurisdiction area based on the calculated traffic index.

The traffic-sensing control of central apparatus 6 includes, for example, “system control” that controls one group of traffic signal devices at intersection Ji belonging to a predetermined system section, “wide area control (area traffic control)” in which the system control is extended to a road network, and the like.

In Japan, control methods of traffic signal controller 12 by central apparatus 6 are roughly classified into a “step-by-step movement control type” and a “table control type”.

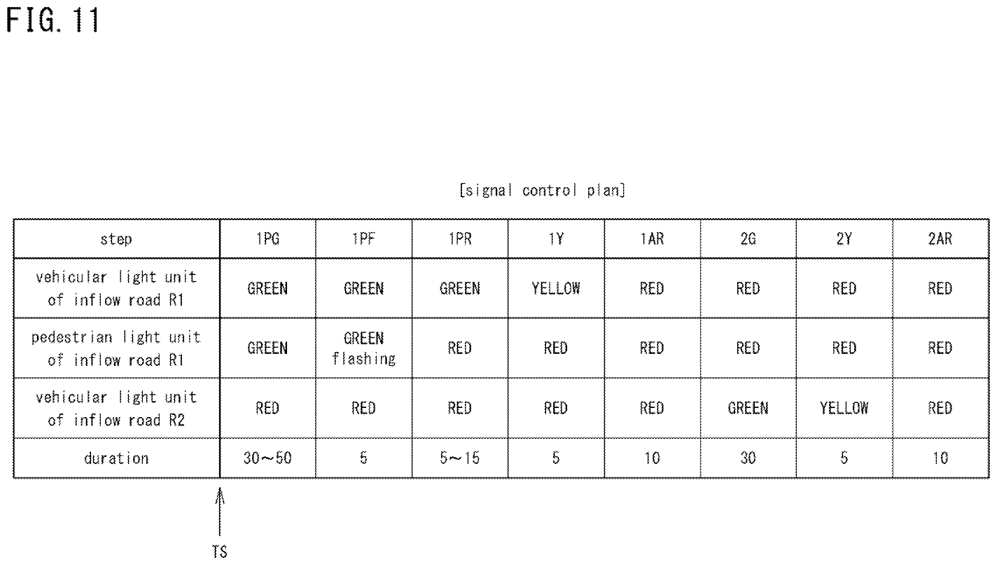

The step-by-step movement control type is a method in which central apparatus 6 determines a signal control plan (for example, FIG. 11) in which a duration for each of steps of signal light unit 11 is set, and transmits a control signal (step-by-step movement command) instructing turning on or off of a predetermined light color to traffic signal controller 12 at a time when the step is switched in the determined signal control plan.

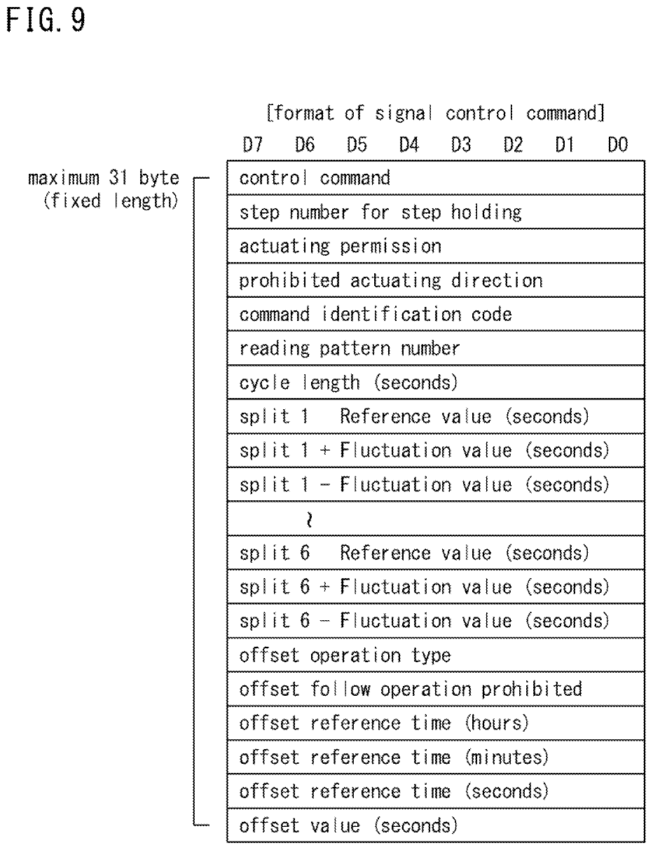

The table control type is a method in which central apparatus 6 transmits a “signal control command” (see FIG. 9) serving as original data of a signal control plan to traffic signal controller 12, and traffic signal controller 12 determines the signal control plan (for example, FIG. 11) based on the received signal control command.

Traffic signal controller 12 switches a display of signal light unit 11 according to the signal control plan determined by itself. The signal control plan is determined for each cycle for the one cycle. The traffic control system of the present embodiment supports the table control type.

Upon executing the traffic-sensing control, central apparatus 6 generates a signal control command including signal control parameters such as a cycle, a split, and an offset. Central apparatus 6 transmits the generated signal control command to traffic signal controller 12 at intersection Ji that is a control target.

Traffic signal controller 12 transmits signal control execution information indicating details of control executed in the previous cycle to central apparatus 6 at the start of the current cycle.

Information stored in the signal control execution information includes a cycle start time of the previous cycle (start time of the first step), the number of seconds of each executed step, a sensing execution type indicating a type of executed local actuated control, detected information (traffic volume and occupation time) of the vehicle sensor and the like.

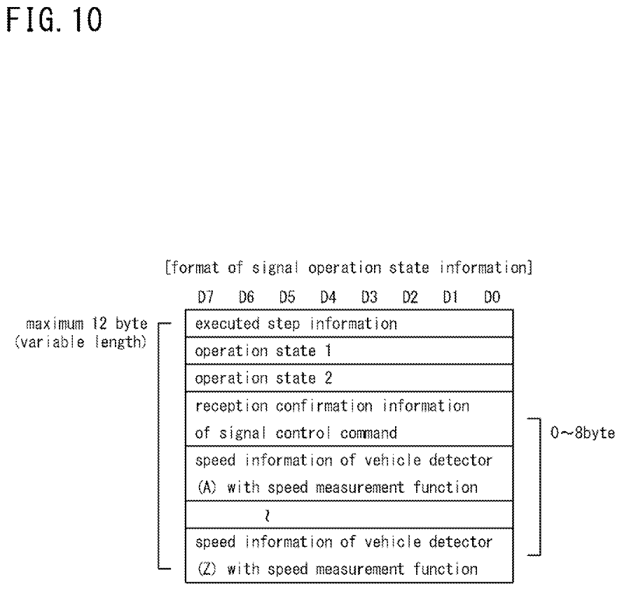

Traffic signal controller 12 transmits a “signal operation state information” (see FIG. 10) indicating an operation state of the current cycle to central apparatus 6 at a cycle (for example, every second) shorter than a transmission cycle of the signal control execution information.

The signal operation state information includes, for example, executed step information including a signal aspect state being executed and a step number, an operation state for notifying an operation abnormality (timer abnormality, CPU abnormality, or the like) of the traffic signal controller, and the like. The executed step information is always transmitted to central apparatus 6 at a timing when the step progresses.

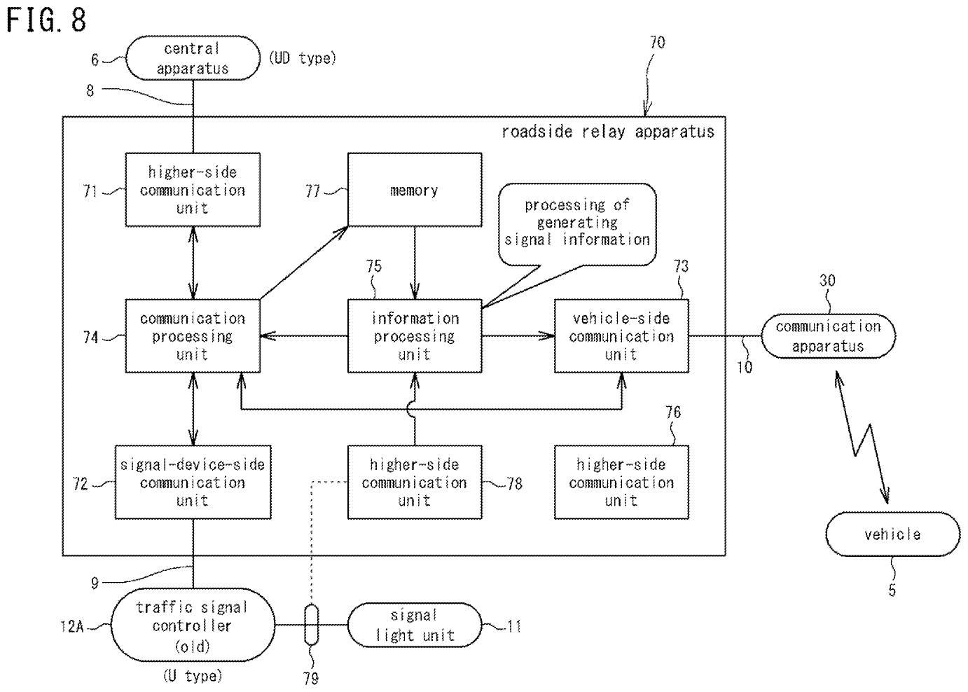

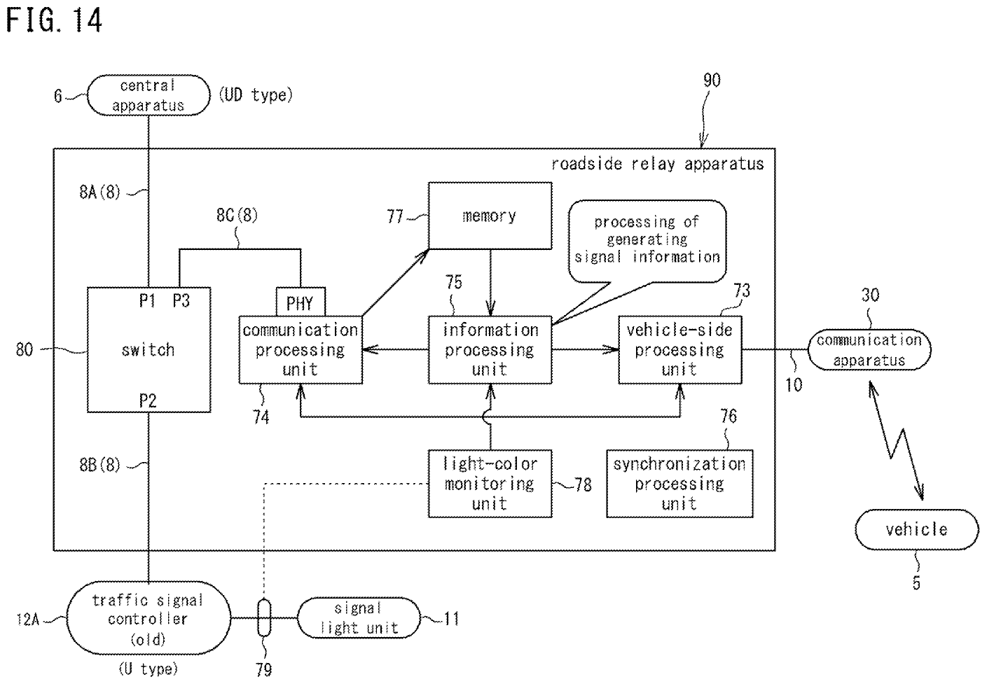

Although not illustrated in FIG. 1, in a case where roadside relay apparatuses 70 and 90 (see FIGS. 8 and 14) are connected to respective traffic signal controllers 12 near intersection Ji, roadside relay apparatuses 70 and 90 are also included in components of the traffic control system.

### [Roadside Apparatus Around Intersection]

FIG. 2 is a road plan view illustrating an example of a roadside apparatus around an intersection.

Traffic signal controller 12 installed at intersection J1 illustrated in FIG. 2 is a traffic signal controller 12A (hereinafter referred to as an “old controller”) having no communication interface for roadside communication device 3.

FIG. 3 is a road plan view illustrating another example of a roadside apparatus around an intersection.

Traffic signal controller 12 installed at intersection J4 illustrated in FIG. 3 is a traffic signal controller (hereinafter also referred to as a “new controller”) 12B having a communication interface for roadside communication device 3.

With respect to traffic signal controller 12, a common reference numeral “12” will be used to describe common matters for old and new traffic signal controllers. In addition, when matters specific to the old controller are described, a reference numeral “12A” which represents the old model is used, and when matters specific to the new controller are described, a reference numeral “12B” that represents the new model is used.

As illustrated in FIGS. 2 and 3, roadside apparatus at each of intersections J1 and J4 includes traffic signal device 1 and roadside sensor 2. Traffic signal device 1 includes the plurality of signal light units 11 disposed for each of inflow roads and traffic signal controller 12 connected to each of signal light units 11 via signal control lines 13.

Upon receiving the signal control command from central apparatus 6, traffic signal controller 12 determines a timing for switching a light color of each of signal light units 11 according to the received signal control command (centralized control).

When traffic signal controller 12 does not receive the signal control command from central apparatus 6, traffic signal controller 12 performs fixed-cycle control for setting a signal control plan according to a time zone. At intersection Ji where the local actuated control based on the detected information is executed, traffic signal controller 12 may change a variable step included in the signal control plan within a range specified by the signal control command.

In each of intersection J1 in FIG. 2 and intersection J4 in FIG. 3, roadside sensor 2 is connected to traffic signal controller 12 via communication line 9. Therefore, traffic signal controller 12 has a function of relaying wired communication between roadside sensor 2 and central apparatus 6.

In intersection J4 in FIG. 3, roadside communication device 3 is connected to a new controller 12B via communication line 10 different from communication line 9. Therefore, new controller 12B also has a function of relaying wired communication between roadside communication device 3 and central apparatus 6.

In each of intersection J1 in FIG. 2 and intersection J4 in FIG. 3, roadside sensor 2 transmits measured sensor information to traffic signal controller 12. Traffic signal controller 12 transfers the sensor information received from roadside sensor 2 to central apparatus 6.

In intersection J4 in FIG. 3, roadside communication device 3 is installed near intersection J4 so as to be able to wirelessly communicate with vehicle 5 that passes through an inflow road of intersection J4. Accordingly, roadside communication device 3 can receive a communication frame including vehicle information S1 transmitted and received using inter-vehicle communication.

Upon receiving vehicle information S1 from on-vehicle communication device 4, roadside communication device 3 transmits the received vehicle information S1 to new controller 12B. New controller 12B transfers vehicle information S1 received from roadside communication device 3 to central apparatus 6.

Upon receiving provided information S2 for a vehicle from traffic signal controller 12, roadside communication device 3 generates a communication frame including the received provided information S2 and transmits the generated communication frame by broadcast.

Provided information S2 for a vehicle includes, for example, traffic congestion information, regulation information, and road linear information near intersection Ji.

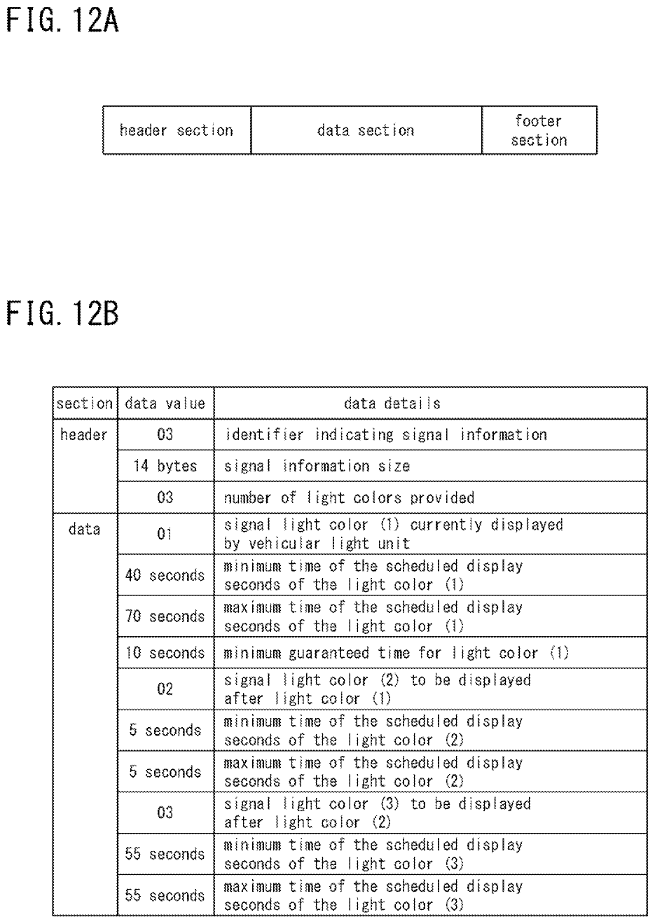

In a case where new controller 12B supports a DSSS (Driving Safety Support System), new controller 12B can output signal information (see FIG. 12) to roadside communication device 3 as provided information S2 for a vehicle. The signal information is information indicating a scheduled display time of signal light unit 11 after the current time, and includes, for example, the scheduled number of seconds to be displayed (remaining seconds) for each of light colors for each of inflow roads.

### [Internal Configuration of Central Apparatus]

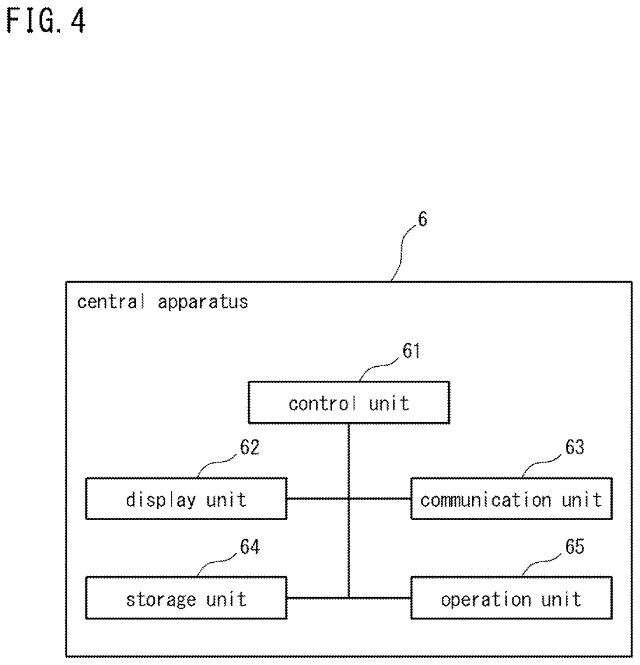

FIG. 4 is a block diagram illustrating an example of an internal configuration of central apparatus 6.

As illustrated in FIG. 4, central apparatus 6 includes a control unit 61, a display unit 62, a communication unit 63, a storage unit 64, and an operation unit 65.

Control unit 61 of central apparatus 6 integrally performs collection, processing (calculation), and recording of various information, traffic signal control, information provision, and the like. Control unit 61 is connected to each of hardware units via an internal bus, and controls an operation of each of the units.

Control unit 61 of central apparatus 6 is formed of an arithmetic processing unit. The arithmetic processing unit includes a central processing unit (CPU) and a main memory formed of a random access memory (RAM).

The CPU of control unit 61 reads a computer program stored in storage unit 64 into the main memory, and performs various types of information processing according to the program. Control unit 61 may include an integrated circuit such as a field-programmable gate array (FPGA) and an application specific integrated circuit (ASIC).

Control unit 61 of central apparatus 6 executes the above-described system control and wide area control (area traffic control). Specifically, control unit 61 performs the traffic-sensing control in which signal control parameters (split, cycle length, and offset) are set for each of intersections Ji based on a traffic index (for example, incoming traffic volume) calculated from collected sensor information or the like.

Communication unit 63 of central apparatus 6 includes a communication interface and is connected to a roadside apparatus other than the central apparatus via communication line 8.

Communication unit 63 transmits, to each of traffic signal controllers 12, signal control command that is generated for each of predetermined control cycle, and traffic information such as traffic congestion information and regulation information. The signal control command is transmitted every control cycle (for example, 1.0 to 2.5 minutes) of the signal control parameter, and the traffic information is transmitted, for example, every five minutes.

Communication unit 63 of central apparatus 6 can receive, from traffic signal controller 12, the vehicle ID, the position information, and the speed information of vehicle 5 having on-vehicle communication device 4 and a detection signal of roadside sensor 2 including the vehicle sensor almost in real time (for example, at a cycle of 0.1 to 1.0 seconds).

Storage unit 64 of central apparatus 6 includes a hard disk, a semiconductor memory, and other components. Storage unit 64 stores a control program for the traffic-sensing control, a calculation program of signal control parameters used for the traffic-sensing control, and other programs.

Storage unit 64 of central apparatus 6 temporarily stores the signal control command and the traffic information generated by control unit 61, and vehicle ID, the position information, the speed information, the detection signal, and the like acquired from the LAN.

Display unit 62 of central apparatus 6 includes one or more liquid crystal displays. Display unit 62 can display a road map of a management area. The road map displayed on display unit 62 includes icons representing traffic signal device 1 and roadside sensor 2 in the jurisdiction area.

Operation unit 65 of central apparatus 6 includes an input interface such as a keyboard and a mouse. An operator of the traffic control center can switch a screen to be displayed on display unit 62 by an operation of inputting to operation unit 65.

### [Internal Configuration of Traffic Signal Controller]

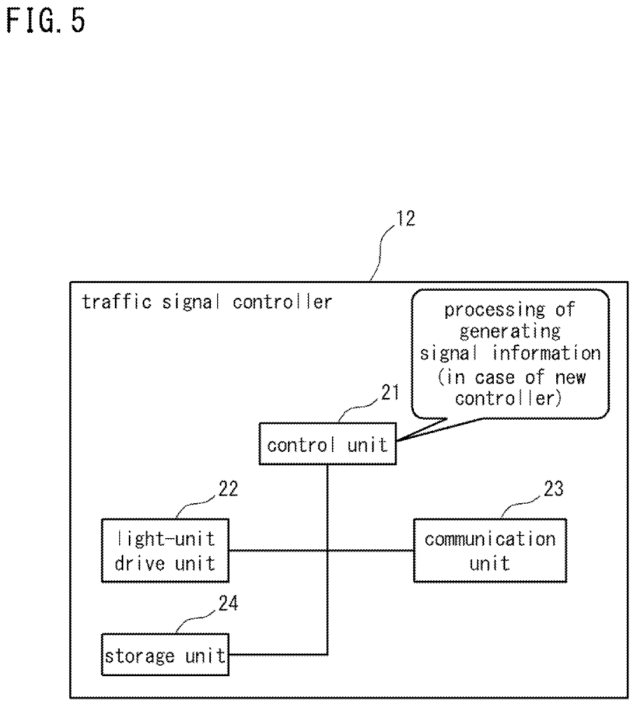

FIG. 5 is a block diagram illustrating an example of an internal configuration of traffic signal controller 12.

As illustrated in FIG. 5, traffic signal controller 12 includes a control unit 21, a light-unit drive unit 22, a communication unit 23, and a storage unit 24. Control unit 21 is connected to light-unit drive unit 22, communication unit 23, and storage unit 24 via an internal bus.

Control unit 21 of traffic signal controller 12 is formed of an arithmetic processing unit. The arithmetic processing unit includes a CPU and a main memory formed of a RAM.

The CPU of control unit 21 reads a computer program stored in storage unit 24 into the main memory, and performs various types of information processing according to the program. Control unit 21 may include an integrated circuit such as the FPGA and the ASIC.

Control unit 21 of traffic signal controller 12 creates a signal control plan based on the signal control parameters included in the signal control command that is generated by central apparatus 6.

Control unit 21 generates a control signal (step-by-step movement signal) for turning on/off each of signal lights included in signal light unit 11 based on the created signal control plan, and outputs the generated control signal to light-unit drive unit 22.

Light-unit drive unit 22 is connected to signal light unit 11 by a signal control line 13 (see FIGS. 2 and 3) that includes a power line. Light-unit drive unit 22 includes a semiconductor relay (not illustrated) that switches a signal light color of signal light unit 11 according to the control signal input from control unit 21.

Specifically, light-unit drive unit 22 turns on/off an AC voltage or a DC voltage supplied to each of signal lights of green, yellow, red, and the like included in signal light unit 11 according to the control signal input from control unit 21.

Communication unit 23 of traffic signal controller 12 has a communication interface for performing wired communication with central apparatus 6 and a communication interface for performing wired communication with roadside sensor 2.

Upon receiving the signal control command generated by central apparatus 6, communication unit 23 of traffic signal controller 12 outputs the received signal control command to control unit 21. When the signal control execution information or the signal operation state information is input from control unit 21, communication unit 23 transmits the input information to central apparatus 6. Upon receiving the sensor information from roadside sensor 2, communication unit 23 transfers the received sensor information to central apparatus 6.

In a case where traffic signal controller 12 is new controller 12B, communication unit 23 further includes a communication interface for performing wired communication with roadside communication device 3.

Accordingly, upon receiving the traffic information such as traffic congestion information is received from central apparatus 6, communication unit 23 of new controller 12B transfers the received traffic information to roadside communication device 3. Also, upon receiving the vehicle information from roadside communication device 3, communication unit 23 transfers the received vehicle information to central apparatus 6.

Storage unit 24 of traffic signal controller 12 includes a hard disk, a semiconductor memory, and the like. Various computer programs executed by control unit 21 are stored in storage unit 24.

The computer programs stored in storage unit 24 include a communication control program for relaying various reception data such as a signal control command, traffic information, sensor information, and vehicle information to an appropriate transmission destination.

In a case where traffic signal controller 12 is new controller 12B that supports the DSSS, the computer programs stored in storage unit 24 includes a program for causing control unit 21 to execute a “processing of generating signal information” for a vehicle.

The processing of generating signal information performed by traffic signal controller 12B is substantially the same as a processing of generating signal information performed by each of roadside relay apparatuses 70 and 90 (see FIGS. 8 and 14) described later. Therefore, details of the processing of generating signal information will be described later.

Control unit 21 of new controller 12B generates signal information for a vehicle, and outputs the generated signal information to communication unit 23.

Communication unit 23 of new controller 12B transmits the input signal information to roadside communication device 3. Roadside communication device 3 transmits, by broadcast, a communication frame including the received signal information to vehicle 5 in a predetermined transmission cycle (for example, 100 milliseconds).

### [Problem and Solution of Traffic Control System]

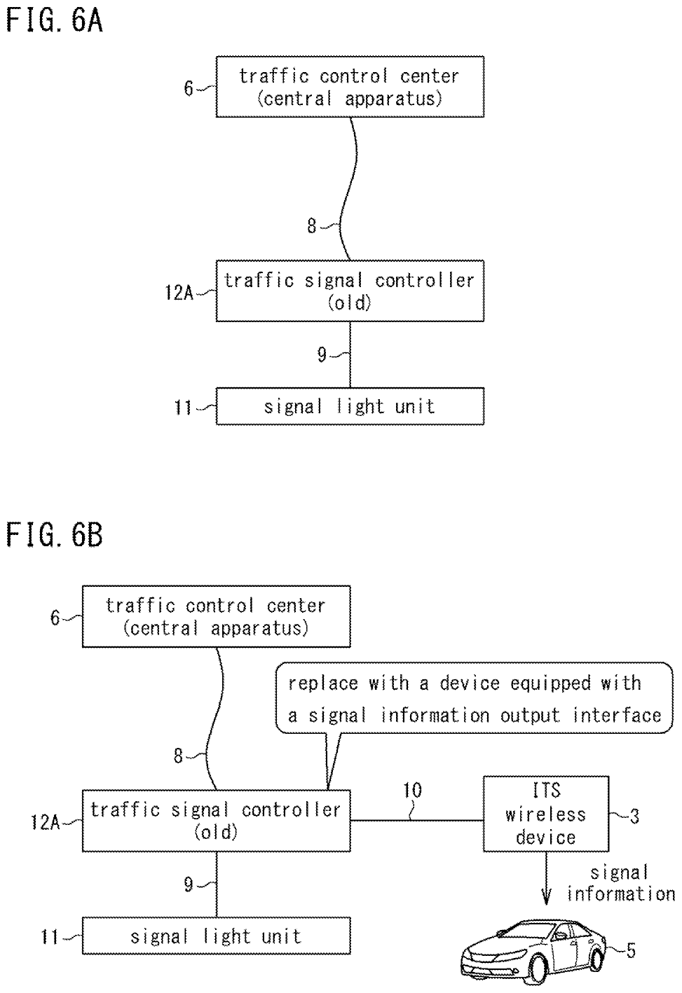

FIG. 6A is a schematic diagram illustrating a connection configuration between old controller 12A and another communication node.

FIG. 6B is a schematic diagram illustrating a connection configuration between new controller 12B and another communication node.

In a DSSS application, signal information generated by new controller 12B is provided to vehicle 5 by roadside communication device 3 that supports ITS wireless communication. Therefore, a driver of vehicle 5 can quickly determine whether or not to be able to pass through intersection Ji to be passed based on the received signal information, and can drive safely and smoothly.

In a case where vehicle 5 is an automated driving vehicle, a current signal light color sensed by an on-vehicle sensor is compared with signal information provided from an infrastructure side, thereby improving a recognition accuracy of the signal light color.

In this manner, considering that provision of signal information is useful for automated driving, it is preferable that signal information at all intersections Ji included in a traffic route of vehicle 5 that performs automated driving can be provided to vehicle 5.

In the traffic control system of FIG. 1, if each of old controllers 12A existing at intersections J1 to J3 and J7 to J12 is replaced with new controller 12B or each of old controllers 12A is modified so as to be able to communicate with roadside communication devices 3, a system for providing signal information useful for the automated driving vehicle can be constructed.

However, in Japan, for example, since most of traffic signal controllers 12 are old controllers 12A that have no communication interfaces for roadside communication devices 3, it is not practical in terms of cost to replace or modify all of old controllers 12A.

In addition, since an exchange cycle of traffic signal controller 12 is about 20 years and it takes a long time to update traffic signal controller 12, it is difficult to rapidly spread a service of providing information for automated driving.

On the other hand, use of cellular communication such as a fifth generation mobile communication system (5G) has been studied as a communication system for wirelessly providing information to a vehicle. However, since traffic signal controller 12 includes no communication interface for communicating with a base station, it is necessary to replace or modify traffic signal controller 12.

In order to solve the above issue, the present inventors have invented a roadside relay apparatus (hereinafter also referred to as a “signal conversion adapter”) 70 that can be installed near traffic signal controller 12. Roadside relay apparatus 70 has the following functions 1 to 3.

Function 1: a function of relaying communication between central apparatus 6 and traffic signal controller 12A

Function 2: a function of generating signal information for a vehicle by using a control command (for example, a signal control command) for controlling traffic signal controller 12A generated by central apparatus 6 and details of control (for example, signal operation state information) which traffic signal controller 12A has executed based on the control command.

Function 3: a function of communicating with communication apparatus 30 belonging to a communication system (for example, an ITS wireless system, a mobile communication system, or the like) that wirelessly provides signal information

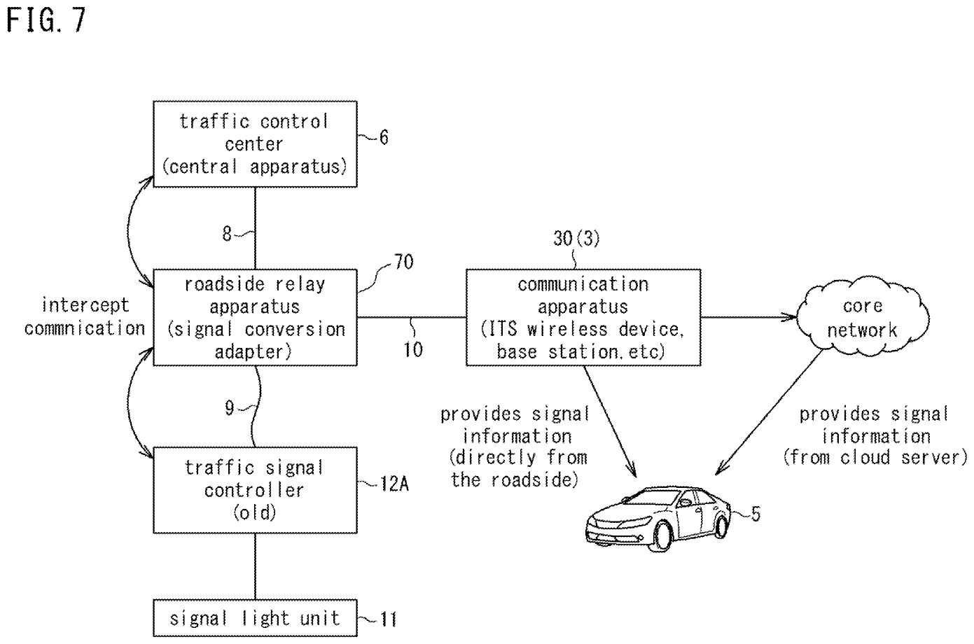

FIG. 7 is a schematic diagram illustrating an example of a connection configuration between roadside relay apparatus 70 and another communication node.

As illustrated in FIG. 7, communication line 8 as a transmission line for central apparatus 6, communication line 9 as a transmission line for traffic signal controller 12A, and communication line 10 (for example, a serial communication line, a LAN cable, or an optical line) as a transmission line for communication apparatus 30 for a vehicle are connected to roadside relay apparatus (signal conversion adapter) 70.

Router 7 or a relay device that can perform protocol conversion may be interposed in a communication route between signal conversion adapter 70 and central apparatus 6.

Similarly, a relay device such as a LAN switch or a media converter may be interposed in a communication route between signal conversion adapter 70 and communication apparatus 30.

Signal conversion adapter 70 includes a first communication interface to which communication line (first line) 8 is connected, a second communication interface to which communication line (second line) 9 is connected, and a third communication interface to which communication line (third line) 10 is connected.

Signal conversion adapter 70 has a function of converting and relaying a communication protocol between communication lines 8 and 9. Therefore, signal conversion adapter 70 behaves as traffic signal controller 12A with respect to central apparatus 6, and behaves as central apparatus 6 with respect to traffic signal controller 12A.

In a case where the first communication interface and the second communication interface are based on the same communication standard (for example, UD-type transmission method), protocol conversion between both communication interfaces is unnecessary, and the same type of communication line is used for communication lines 8 and 9.

Since signal conversion adapter 70 relays a downward frame transmitted by central apparatus 6 to traffic signal controller 12A and an upward frame transmitted by traffic signal controller 12A to central apparatus 6, it is possible to extract information included in these communication frames.

Therefore, signal conversion adapter 70 emulates a control operation of traffic signal controller 12A based on information (signal control command or the like) included in the communication frame, and generates signal information for a vehicle. Signal conversion adapter 70 can also determine an operation abnormality of traffic signal controller 12A based on information (for example, signal operation state information) included in the upward frame.

Signal conversion adapter 70 transmits the generated signal information to communication apparatus 30. Communication apparatus 30 includes, for example, an ITS wireless device (roadside communication device 3) or a base station for cellular communication.

In a case where communication apparatus 30 is the ITS wireless device, the signal information is wirelessly transmitted by the ITS wireless device to on-vehicle communication device 4 of vehicle 5. In a case where communication apparatus 30 is the base station, the signal information is transferred from the base station to a cloud server of a core network. The cloud server transfers the signal information to the same or another base station, and the received base station wirelessly transmits the signal information to a mobile terminal of vehicle 5.

### [Internal Configuration of Roadside Relay Apparatus]

FIG. 8 is a block diagram illustrating an example of an internal configuration of roadside relay apparatus 70.

As illustrated in FIG. 8, roadside relay apparatus 70 includes a higher-side communication unit 71, a signal-device-side communication unit 72, a vehicle-side communication unit 73, a communication processing unit 74, an information processing unit 75, a synchronization processing unit 76, a memory 77, and a light-color monitoring unit 78.

Higher-side communication unit 71 is a communication interface that transmits and receives an electric signal according to a predetermined transmission method (communication protocol) to and from central apparatus 6. In this embodiment, it is assumed that the transmission method of central apparatus 6 is, for example, “UD-type transmission method” that enables IP communication.

Communication line (first line) 8 used for wired communication with central apparatus 6 is connected to higher-side communication unit (first communication unit) 71.

Higher-side communication unit 71 demodulates an electric signal (carrier signal) input from communication line 8 to reproduce a downward frame. Higher-side communication unit 71 outputs the reproduced downward frame to communication processing unit 74.

Higher-side communication unit 71 modulates an upward frame input from communication processing unit 74 into an electric signal (carrier signal) having a predetermined frequency. Higher-side communication unit 71 transmits the modulated electric signal (carrier signal) to communication line 8.

Signal-device-side communication unit 72 is a communication interface that transmits and receives an electric signal according to a predetermined transmission method to and from traffic signal controller 12A. In this embodiment, it is assumed that the transmission method of traffic signal controller 12A is, for example, “U-type transmission method” in which the IP communication is impossible.

Communication line (second line) 9 used for wired communication with traffic signal controller 12A is connected to signal-device-side communication unit (second communication unit) 72.

Signal-device-side communication unit 72 demodulates an electric signal (carrier signal) input from communication line 9 to reproduce an upward frame. Signal-device-side communication unit 72 outputs the reproduced upward frame to communication processing unit 74.

Signal-device-side communication unit 72 modulates a downward frame input from communication processing unit 74 into an electric signal (carrier signal) having a predetermined frequency. Signal-device-side communication unit 72 transmits the modulated electric signal (carrier signal) to communication line 9.

Vehicle-side communication unit 73 is a communication interface that transmits and receives an electric signal according to a predetermined communication protocol to and from communication apparatus 30. As a transmission method of communication apparatus 30, for example, a high-speed serial transmission method or a transmission method that enables IP communication such as a wired LAN can be adopted.

Communication line (third line: for example, a serial cable or an ether cable) 10 is connected to vehicle-side communication unit (third communication unit) 73. Communication line (third line) 10 is used for wired communication between roadside relay apparatus 70 and communication apparatus 30. Communication apparatus 30 belongs to a communication system that wirelessly provides information to vehicle 5.

Vehicle-side communication unit 73 demodulates an electric signal (carrier signal) received from communication line 10 to reproduce an upward frame. Vehicle-side communication unit 73 outputs the reproduced upward frame to communication processing unit 74.

Vehicle-side communication unit 73 modulates a downward frame input from communication processing unit 74 into an electric signal (carrier signal) having a predetermined frequency. Vehicle-side communication unit 73 outputs the modulated electric signal (carrier signal) to communication line 10.

In a case where communication apparatus 30 is a base station using an optical line, vehicle-side communication unit 73 includes an optical transceiver. Details of processing by vehicle-side communication unit 73 in this case are as follows.

Vehicle-side communication unit 73 converts an optical signal input from an optical fiber (third line) 10 into an electric signal to reproduce an upward frame. Vehicle-side communication unit 73 outputs the converted upward frame to communication processing unit 74.

Vehicle-side communication unit 73 converts a downward frame input from communication processing unit 74 into an optical signal having a predetermined wavelength. Vehicle-side communication unit 73 transmits the converted optical signal to optical fiber 10.

Communication processing unit 74, information processing unit 75, synchronization processing unit 76, memory 77, and light-color monitoring unit 78 are functional parts of an arithmetic processing device including a CPU and a RAM, for example.

The CPU of the arithmetic processing device reads a computer program installed in a storage device (not illustrated) into the main memory (RAM), and performs various types of information processing according to the program. The arithmetic processing unit can be formed of one or more integrated circuits such as an FPGA and an ASIC other than the CPU, or can be formed of one or more integrated circuits such as an FPGA and an ASIC in addition to the CPU.

Communication processing unit 74 performs predetermined protocol conversion on a communication frame transmitted and received between central apparatus 6 and traffic signal controller 12A to relay the converted communication frame.

Specifically, communication processing unit 74 converts a downward frame according to the UD-type transmission method input from higher-side communication unit 71 into a format according to the U-type transmission method, and outputs the converted downward frame to signal-device-side communication unit 72. Conversely, communication processing unit 74 converts an upward frame according to the U-type transmission method input from signal-device-side communication unit 72 into a format according to the UD-type transmission method, and outputs the converted upward frame to higher-side communication unit 71.

When a signal control command is included in the downward frame input from higher-side communication unit 71, communication processing unit 74 extracts the signal control command from the downward frame and temporarily stores the extracted signal control command in memory 77.

When an upward frame input from signal-device-side communication unit 72 includes signal operation state information, communication processing unit 74 extracts the information from the upward frame and temporarily stores the extracted information in memory 77.

Among information necessary for a processing of generating signal information, if there is information that is not transmitted and received in communication between central apparatus 6 and traffic signal controller 12A (the number of steps included in one cycle, a correspondence relation between the step number and the light color of each of inflow roads, and the like that are implicitly set between both apparatuses), the information may be permanently stored in memory 77 by manual setting or the like.

Communication processing unit 74 performs predetermined protocol conversion on a communication frame transmitted and received between central apparatus 6 and communication apparatus 30 to relay the converted communication frame.

Specifically, communication processing unit 74 converts a downward frame according to the UD-type transmission method input from higher-side communication unit 71 into a format according to a transmission method adopted by communication apparatus 30, and outputs the converted downward frame to vehicle-side communication unit 73. Conversely, communication processing unit 74 converts an upward frame according to a transmission method adopted by communication apparatus 30 input from vehicle-side communication unit 73 into the format according to the UD-type transmission method, and outputs the converted upward frame to higher-side communication unit 71.

Information provided by central apparatus 6 to communication apparatus 30 in the downward frame includes, for example, traffic information such as traffic congestion information or regulation information.

Information provided by communication apparatus 30 to central apparatus 6 in the upward frame includes, for example, inter-vehicle communication information generated by vehicle 5.

Information processing unit 75 can emulate a control operation similar to that of traffic signal controller 12A based on the signal control command and the signal operation state information stored in memory 77.

For example, information processing unit 75 can create a signal control plan based on signal control parameters (cycle, split, offset, and the like) included in the signal control command. Information processing unit 75 can also perform the same type of local actuated control as traffic signal controller 12A based on the type of local actuated control specified by the signal control command.

Information processing unit 75 generates signal information for a vehicle based on the created signal control plan. Details of the “processing of generating signal information” by information processing unit 75 will be described later.

When information processing unit 75 generates the signal information for a vehicle, information processing unit 75 generates a downward frame including the generated signal information and outputs the generated downward frame to vehicle-side communication unit 73. Vehicle-side communication unit 73 transmits the downward frame including the input signal information to communication apparatus 30.

Synchronization processing unit 76 is a processing unit for synchronizing a time with other communication nodes such as central apparatus 6 by a predetermined synchronization method.

As a synchronization method of synchronization processing unit 76, for example, a global positioning system (GPS)-based synchronization in which the time is synchronized with a 1PPS (Pulse Per Second) signal acquired by a GPS receiver or a synchronization method using a communication frame such as an NTP (Network Time Protocol) and a PTP (Precision Time Protocol) can be adopted.

Communication processing unit 74 determines a transmission timing and the like of the communication frame according to a local time generated by synchronization processing unit 76.

Information processing unit 75 determines a cycle start time Ts and the like of the created signal control plan according to the local time generated by synchronization processing unit 76.

Light-color monitoring unit 78 is connected to light-color sensor 79. Light-color sensor 79 is formed of, for example, an ammeter that detects a current flowing from light-unit drive unit 22 to signal light unit 11.

Light-color monitoring unit 78 determines the current light color of signal light unit 11 based on a current value detected by light-color sensor 79. For example, while the current of the red signal light is on, light-color monitoring unit 78 determines that the determination result of the current light color is red. The same applies to other light colors.

Light-color sensor 79 may be an image sensor (for example, a CCD camera) that can capture moving images. In this case, light-color monitoring unit 78 may determine the current light color of signal light unit 11 based on an RGB value or the like of a light-unit portion included in the image data input from light-color sensor 79.

Light-color monitoring unit 78 outputs the determination result of the current light color to information processing unit 75. Information processing unit 75 uses the determination result of the current light color for correction of a signal control plan, determination of whether or not there is an operation abnormality of traffic signal controller 12A, and the like.

For example, information processing unit 75 corrects a duration of a step in the signal control plan based on a change timing of the current light color. When information processing unit 75 detects an abnormality of a transition state of the current light color (for example, a green signal in both an east-west direction and a south-north direction), information processing unit 75 generates a communication frame directed to central apparatus 6 including identification information and details of the abnormality of traffic signal controller 12A and outputs the generated communication frame to communication processing unit 74.

### [Details of Processing of Generating Signal Information]

Processing of generating signal information executed by information processing unit 75 includes the following processings 1 to 4. Information processing unit 75 executes the following processings 1 to 4 every sufficiently short predetermined calculation cycle (for example, every 100 milliseconds), and updates the signal information nearly in real time.

When information processing unit 75 outputs the signal information to vehicle-side communication unit 73, information processing unit 75 outputs the latest (most recent) signal information at a time of the output.

Processing 1) Creation of Signal Control Plan

Information processing unit 75 creates a signal control plan to be applied to the next cycle based on the signal control command (see FIG. 9) and the signal operation state information (see FIG. 10) stored in memory 77.

The signal control plan includes a plurality of steps included in one cycle, a duration (for example, the number of seconds) of each of the steps, a cycle start time Ts, and the like (see FIG. 11).

Information processing unit 75 obtains a plurality of the steps included in the signal control plan and the duration of each of the steps based on the step number, reference values for splits 1 to 6, plus-variation values for splits 1 to 6, minus-variation values for splits 1 to 6, the cycle length, a constant representing a relationship between each of the steps and respective signal aspects, and the like that are included in the signal control command.

Processing 2) Calculation of Duration of Variable Step

Information processing unit 75 determines whether or not traffic signal controller 12A is executing local actuated control (control for changing a variable step based on detected information by a vehicle sensor) based on actuating permission included in the signal control command.

When the local actuated control is being executed, information processing unit 75 executes local actuated control (for example, dilemma sensing control, bus sensing control, gap sensing control, or the like) of the type specified by the actuating permission included in the signal control command, and reflects the result in the duration of the variable step.

Processing 3) Correction of Duration of Step

When a slight difference equal to or larger than a predetermined value has occurred between a duration (first time) of a step calculated by information processing unit 75 and an execution time (second time) of the step calculated from signal operation state information, information processing unit 75 corrects the first time based on a reception timing of the executed step information transmitted at a time of a step change, and adjusts the duration of each of steps included in the signal control plan to the second time.

Information processing unit 75 may correct a duration of a step calculated by itself based on the determination result of a current light color input from light-color monitoring unit 78.

For example, when a slight difference equal to or larger than a predetermined value has occurred between a switching time of a step and a change time of the current light color, information processing unit 75 increases or decreases the duration of the step by the time difference.

Processing 4) Creation of Signal Information

Information processing unit 75 creates signal information (for example, FIG. 12) according to a predetermined format based on the calculated duration for each of steps. The signal information includes a light color for each of inflow roads, a scheduled display time (the number of remaining seconds from the current time) for each of light colors after the current time, and the like.

### [Formats of Signal Control Command and Signal Operation State Information]

FIG. 9 is a diagram illustrating an example of a format of a signal control command. FIG. 10 is a diagram illustrating an example of a format of signal operation state information.

The formats illustrated in FIGS. 9 and 10 are formats defined in “U-type traffic signal controller, U-type communication application standard” issued by Universal Traffic Management Systems (UTMS) Society of Japan. Thus, details of data included in the formats of FIGS. 9 and 10 are described in the above standard.

### Specific Example of Signal Control Plan

FIG. 11 is a table illustrating an example of a signal control plan created by roadside relay apparatus 70.

In the example illustrated in FIG. 11, one cycle includes the following eight steps.

An inflow road R1 is an inflow road that extends in a first direction (for example, an east-west direction) and in which a pedestrian light unit is installed. An inflow road R2 is an inflow road that extends in a second direction (for example, a north-south direction) intersecting the first direction and in which no pedestrian light unit is installed.

1PG: Both of vehicular light unit and pedestrian light unit are green for inflow road R1.

1PF: Vehicular light unit is green and pedestrian light unit is flashing green for inflow road R1.

1PR: Vehicular light unit is green and pedestrian light unit is red for inflow road R1.

1Y: Vehicular light unit is yellow and pedestrian light unit is red for inflow road R1.

1AR: Both of inflow road R1 and inflow road 2 are red (all red)

2G: Vehicular light unit is green for inflow road R2

2Y: Vehicular light unit is yellow for inflow road R2

2R: Vehicular light unit is red for inflow road R2

In the example of FIG. 11, among the eight steps, each duration of steps 1PG and 1PR is not determined in advance unlike the other steps, and is calculated as a duration having a range. This means that steps 1PG and 1PR are variable steps that may vary according to local actuated control or the like.

### [Format of Signal Information]

FIG. 12 is a diagram illustrating an example of a format of signal information for a vehicle.

Specifically, FIG. 12A is a diagram illustrating a data structure of the signal information, and FIG. 12B is an explanatory diagram illustrating data values and details of data stored in a header section and a data section of the signal information.

The signal information illustrated in FIG. 12B is signal information related to inflow road R1 in the signal control plan in FIG. 10.

As illustrated in FIG. 12A, the signal information for a vehicle has a data structure including the header section, the data section, and a footer section.

The header section includes an identifier indicating signal information, a size of the signal information, and the number of light colors to be provided (three in the illustrated example). The footer section stores a CRC value and the like. The data section stores scheduled display times (the number of seconds in the illustrated example) of the light colors (1) to (3) corresponding to the number of light colors defined in the header section.

In FIG. 12B, the correspondence relation between data values (codes) of the light colors (1) to (3) and actual signal light colors is as follows.

Signal light color (1) of code “01”=green signal

Signal light color (2) of code “02”=yellow signal

Signal light color (3) of code “03”=red signal

As illustrated in FIG. 12B, for inflow road R1, the shortest time of the scheduled number of seconds to be displayed for the light color (1) (=green signal) is 40 seconds, and the longest time is 70 seconds.

In the minimum guaranteed time of the light color (1), a total value of the shortest times in a case of performing, as a vehicular light unit, a same display in steps after the step (1PG) being executed is stored. In the example of FIG. 12B, a total value of the shortest times for 1PF and 1PR is stored as 10 seconds.

For inflow road R1, each of the shortest time and the longest time of the scheduled number of seconds to be displayed for the light color (2) (=yellow signal) is 5 seconds.

For inflow road R1, each of the shortest time and the longest time of the scheduled number of seconds to be displayed for the light color (3) (=red signal) is 55 seconds. In this manner, the scheduled number of seconds to be displayed for the light color in which the shortest time and the longest time coincide with each other is fixed. The scheduled number of seconds to be displayed may be expressed in a unit of 100 milliseconds or 10 milliseconds, and a format itself is not limited to the form illustrated in FIG. 12.

### [Overall Configuration of Abnormality Monitoring System]

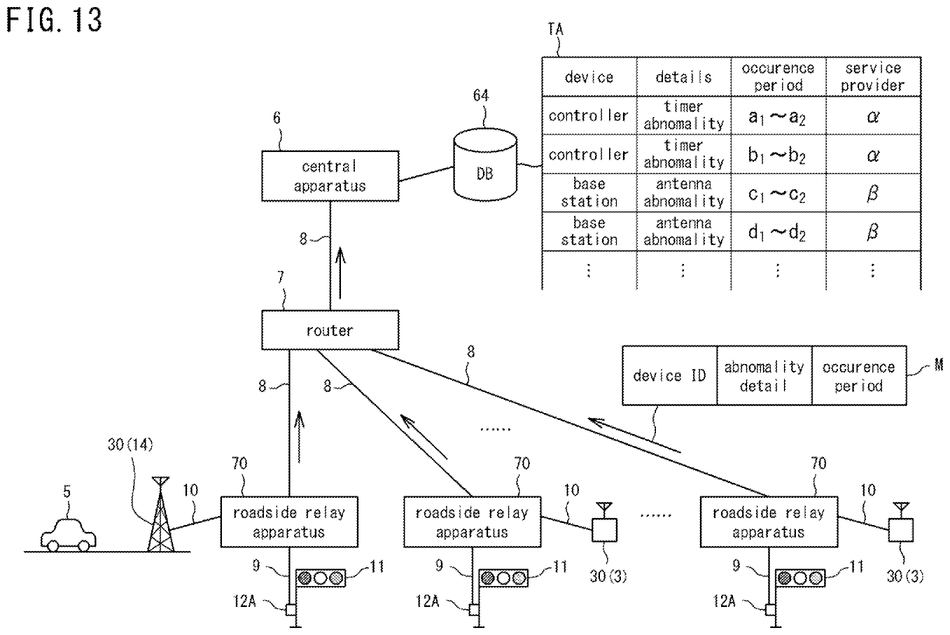

FIG. 13 is a schematic diagram illustrating an example of an overall configuration of an abnormality monitoring system according to the present embodiment.

As illustrated in FIG. 13, the abnormality monitoring system of the present embodiment includes central apparatus 6, at least one roadside relay apparatus 70, traffic signal controller 12A connected to roadside relay apparatus 70, communication apparatus 30 and the like.

Since three communication lines 8 to 10 are each connected to roadside relay apparatus 70, a service provider that operates communication devices on communication lines 8 and 9 may be different from a service provider that operates communication devices on communication line 10.

Specifically, in a case where communication apparatus 30 is base station 14 for cellular communication, a service provider (for example, a prefecture police) that operates central apparatus 6 and traffic signal controller 12A is different from a service provider (for example, a telecommunication service provider) that operates base station 14.

Therefore, after roadside relay apparatus 70 is installed, when any abnormality that affects a service of providing signal information has occurred, it is preferable to be able to easily determine a portion and details of the abnormality for each of service providers.

Therefore, upon detecting a predetermined abnormality that affects communication, information processing unit 75 of roadside relay apparatus 70 generates an abnormality notification message M that is directed to central apparatus 6 and that includes details of the abnormality, and outputs a communication frame including the generated message M to communication processing unit 74. The abnormality notification message M input to communication processing unit 74 is output to higher-side communication unit 71, and is transmitted to central apparatus 6 by higher-side communication unit 71.

The abnormality detected by information processing unit 75 includes at least one of an abnormality (first abnormality) in the roadside relay apparatus, an abnormality (second abnormality) in traffic signal controller 12, or an abnormality (third abnormality) in a communication device (communication apparatus 30, a base station, or the like) that communicates with vehicle-side communication unit 73.

The first abnormality includes, for example, an abnormality of a CPU, a timer, a power supply, or the like in the roadside relay apparatus. The second abnormality can be detected from, for example, signal operation state information received by signal-device-side communication unit 72. The third abnormality can be detected from, for example, a message or the like that reports an abnormality and that included in a communication frame received from communication apparatus 30 by vehicle-side communication unit 73.

The abnormality notification message M directed to central apparatus 6 includes identification information (hereinafter referred to as “device ID”) of a communication device in which an abnormality has occurred in addition to details of the abnormality and an occurrence period of the abnormality. As the device ID, for example, a media access control (MAC) address or a serial number of the communication device may be adopted.

As the details of the abnormality, for example, various contents such as a failure of the communication device, a failure of a control target connected to the communication device, a line abnormality, and an abnormality of a network including the communication device are considered.

For example, when operation state information received from traffic signal controller 12B indicates a “timer abnormality” of traffic signal controller 12B, information processing unit 75 generates abnormality notification message M including a device ID of traffic signal controller 12B, the timer abnormality, and an occurrence period of the timer abnormality.

When vehicle-side communication unit 73 receives a message indicating an “antenna abnormality” of base station 14, information processing unit 75 generates abnormality notification message M including a device ID of base station 14, the antenna abnormality, and an occurrence period of the antenna abnormality included in the message.

Storage unit 64 of central apparatus 6 stores a management table TA, and control unit 61 of central apparatus 6 manages the stored management table TA. The management table TA includes a “device”, “details”, an “occurrence period”, a “service provider” and the like as items.

The item of the device is an item that records a type of the communication device in which an abnormality has occurred. The item of the details is an item that records details of the abnormality of the communication device. The item of the occurrence period is an item that records an occurrence period of the abnormality of the communication device. The item of the service provider is an item that records a type of the service provider that operates the communication device.

Storage unit 64 of central apparatus 6 also stores a correspondence table (not illustrated) in which a correspondence relation among a device ID, a type of a communication device, and a type of a service provider is recorded.

Control unit 61 of central apparatus 6 searches the correspondence table using the device ID included in the abnormality notification message M as a key, and determines the type of the communication device in which the abnormality has occurred and the type of the service provider that operates the communication device.

Control unit 61 of central apparatus 6 records the type of the communication device corresponding to the device ID included in the abnormality notification message M as the item of the device of the management table TA.

Similarly, control unit 61 records the details of the abnormality included in the abnormality notification message M as the item of the details of the management table TA. Control unit 61 records the occurrence period of the abnormality included in the abnormality notification message M as the item of the occurrence period of the management table TA. Control unit 61 records the type of the service provider corresponding to the device ID included in the abnormality notification message M as the item of the service provider of the management table.

As described above, according to the abnormality monitoring system of the present embodiment, control unit 61 of central apparatus 6 can automatically create the management table TA described in FIG. 13, for example, for managing the abnormality in the communication device related to the provision of the signal information.

Accordingly, by displaying the management table TA on display unit 62, an operator of the traffic control center can immediately determine the details of the abnormality, the occurrence period of the abnormality, and the type of the service provider operating the communication device for each type of the communication devices in which the abnormality have occurred. Therefore, the operator can quickly perform a response such as reporting the fact and the details of the abnormality occurrence.

In addition, if the occurrence period of the abnormality included in the management table TA is aggregated for a predetermined period (for example, monthly) for each type of service providers, it is possible to evaluate each service provider related to the provision of the signal information.

When there is an abnormality in the communication device related to the provision of the signal information, incorrect signal information may be provided. Therefore, when the above-described abnormality is detected, it is preferable that information processing unit 75 notifies central apparatus 60 and also stops outputting signal information.

Information processing unit 75 may stop outputting signal information only when a predetermined abnormality related to an accuracy of the signal information is detected.

The predetermined abnormality includes, for example, the following cases.

1) A case where a difference between the scheduled number of seconds to be displayed in generated signal information and an actual number of seconds to be displayed obtained from a determination result of a current light color exceeds a predetermined value (for example, 1 second)

2) A case where, from a determination result of a current light color, a green signal is detected or a transition from a green signal to a red signal is detected, in both of an east-west direction and a south-north direction.

### [Modification of Roadside Relay Apparatus]

FIG. 14 is a block diagram illustrating another example of an internal configuration of roadside relay apparatus 90.

Roadside relay apparatus (signal conversion adapter) 90 in FIG. 14 is an apparatus suitable for a case where transmission methods of both of central apparatus 6 and traffic signal controller 12A are the “UD-type transmission methods”.

In the case where the transmission methods of both of central apparatus 6 and traffic signal controller 12A are the same, if the transmission methods support IP communication, it is not necessary to perform a relay processing involving protocol conversion on a communication frame exchanged between central apparatus 6 and traffic signal controller 12A.

Therefore, roadside relay apparatus 90 includes a switch 80 having at least three physical ports P1 to P3. Switch 80 is formed of, for example, an L2 switch or an L3 switch.

A communication line 8A leading to central apparatus 6 is connected to port P1. A communication line 8B leading to traffic signal controller 12A is connected to port P2. A communication line 8C leading to communication processing unit 74 is connected to port P3. Each of communication lines 8A to 8C is formed of communication line 8 used in the UD-type transmission method. Communication processing unit 74 includes a PHY unit to which communication line 8C is connectable.

Route information among physical ports P1 to P3 is set in advance in switch 80. This route information is as follows.

Signal input to port P1: output to ports P2 and P3

Signal input to port P2: output to port P1, P3

Signal input to port P3: output to port P1

Therefore, the downward frame transmitted by central apparatus 6 to traffic signal controller 12A is output not only to traffic signal controller 12A but also to communication processing unit 74.

The upward frame transmitted by traffic signal controller 12A to central apparatus 6, is output not only to central apparatus 6 but also to communication processing unit 74. The upward frame transmitted by communication processing unit 74 to central apparatus 6 is transmitted only to central apparatus 6.

As described above, communication processing unit 74 can acquire (intercept) a communication frame exchanged between central apparatus 6 and traffic signal controller 12A by route control of switch 80.

When a signal control command is included in the acquired downward frame, communication processing unit 74 extracts the signal control command from the downward frame and outputs the signal control command to information processing unit 75.

When signal operation state information is included in the acquired upward frame, communication processing unit 74 extracts the information from the upward frame and outputs the information to information processing unit 75.

In roadside relay apparatus 90 in FIG. 14, switch 80 corresponds to the first communication unit to which communication line (first line) 8A for central apparatus 6 is connected and the second communication unit to which communication line (second line) 8B for traffic signal controller 12A is connected.

Also in roadside relay apparatus 90 in FIG. 14, vehicle-side communication unit 73 corresponds to the third communication unit to which communication line (third line) 10 for communication apparatus 30 is connected.

Furthermore, in the abnormality monitoring system in FIG. 13, roadside relay apparatus 90 in FIG. 14 may be adopted instead of roadside relay apparatus 70.

### [Other Modifications]

The above-described embodiments (including modifications) are illustrative in all aspects and not restrictive. The scope of the present disclosure is defined by the scope of the claims, and is intended to embrace all the modifications within the meaning and range of equivalency of the claims.

In roadside relay apparatus 70 in FIG. 8, a transmission method of traffic signal controller 12A may be an “M-type transmission method” or a “T-type transmission method”. Traffic signal controller 12A of the M-type or T-type transmission method adopts the step-by-step movement control type and does not support the table control type.

Therefore, central apparatus 6 transmits a step-by-step movement command to traffic signal controller 12A and does not transmit a signal control command to traffic signal controller 12A. Therefore, central apparatus 6 may generate a downward frame that is directed to roadside relay apparatus 70 and that includes the signal control command for remotely controlling traffic signal controller 12A and transmits the generated downward frame to communication line 8.

In roadside relay apparatuses 70 and 90 illustrated in FIGS. 8 and 14, communication processing unit 74 may be a processing unit that is not connected to vehicle-side communication unit 73 and does not perform a relay involving protocol conversion or the like for communication between higher-side communication unit 71 and vehicle-side communication unit 73.

Also in roadside relay apparatuses 70 and 90 in this case, since vehicle-side communication unit 73 transmits the signal information for a vehicle input from information processing unit 75 to communication apparatus 30, at least the function of outputting the signal information is maintained.

### REFERENCE SIGNS LIST

1 traffic signal device
2 roadside sensor
3 roadside communication device
4 on-vehicle communication device
5 vehicle
6 central apparatus
7 router
8 communication line (first line)
8A communication line (first line)
8B communication line (second line)
8C communication line
9 communication line (second line)
10 communication line (third line)
11 signal light unit
12 traffic signal controller
12A old controller
12B new controller
13 control line
14 base station
21 control unit
22 light-unit drive unit
23 communication unit
24 storage unit
30 communication apparatus
60 central apparatus
61 control unit
62 display unit
63 communication unit
64 storage unit
65 operation unit
70 roadside relay apparatus (signal conversion adapter)
71 higher-side communication unit (first communication unit)
72 signal-device-side communication unit (second communication unit)
73 vehicle-side communication unit (third communication unit)
74 communication processing unit
75 information processing unit
76 synchronization processing unit
77 memory
78 light-color monitoring unit
79 light-color sensor
80 switch (first communication unit, second communication unit)
90 roadside relay apparatus (signal conversion adapter)

1. A roadside relay apparatus comprising:
a first communication unit to which a first line is connected;
a second communication unit to which a second line is connected;
a third communication unit to which a third line is connected;
a communication processing unit configured to relay or intercept communication between the first communication unit and the second communication unit; and
an information processing unit configured to generate signal information for a vehicle, based on a control command, for controlling a traffic signal controller, received by the first communication unit and based on details of control, performed by the traffic signal controller, received by the second communication unit, and to output the generated signal information to the third communication unit,
the first line being a communication line for wired communication with a central apparatus of a traffic control system,
the second line being a communication line for wired communication with the traffic signal controller,
the third line being a communication line for wired communication with a communication apparatus that belongs to a communication system configured to wirelessly provide information to the vehicle.

2. The roadside relay apparatus according to claim 1, wherein
the second communication unit is configured to
receive executed step information transmitted by the traffic signal controller at a time of a step change, and
the information processing unit is configured to
based on a reception timing of the executed step information, correct a duration of a step in a signal control plan required in generation of the signal information.

3. The roadside relay apparatus according to claim 1, further comprising:
a light-color monitoring unit configured to monitor a current light color of a signal light unit coupled to the traffic signal controller, wherein
the information processing unit is configured to
based on a change timing of the current light color, correct a duration of a step in a signal control plan required in generation of the signal information.

4. The roadside relay apparatus according to claim 1, further comprising:
a light-color monitoring unit configured to monitor a current light color of a signal light unit coupled to the traffic signal controller, wherein
the information processing unit is configured to
based on a transition state of the current light color, determine whether or not there is an abnormality in the traffic signal controller.

5. The roadside relay apparatus according to claim 1, wherein
the information processing unit is configured to
in a case of detecting an abnormality in at least one of a communication device that is the roadside relay apparatus, a communication device configured to communicate with the second communication unit, or a communication device configured to communicate with the third communication unit, generate an abnormality notification directed to the central apparatus and output the generated abnormality notification to the communication processing unit, the abnormality notification including details of the abnormality and identification information of the communication device in which the abnormality has occurred.

6. The roadside relay apparatus according to claim 5, wherein
the information processing unit is configured to
include an occurrence period of the abnormality in the abnormality notification.

7. The roadside relay apparatus according to claim 5, wherein
the information processing unit is configured to
stop outputting the signal information, in the case of detecting the abnormality.

8. A central apparatus configured to communicate with the roadside relay apparatus according to claim 5 in a wired manner, the central apparatus comprising:
a communication unit configured to receive the abnormality notification;
a storage unit configured to store a management table including a device, details, and a service provider as items to be managed; and
a control unit configured to manage the management table, wherein
the control unit is configured to
record, as the item of the device, a type of a communication device corresponding to the identification information included in the received abnormality notification,
record, as the item of the details, the details of the abnormality included in the received abnormality notification, and
record, as the item of the service provider, a type of a service provider corresponding to the identification information included in the received abnormality notification.

9. The central apparatus according to claim 8, wherein
the abnormality notification further includes an occurrence period of the abnormality,
the items to be managed in the management table further include an occurrence period, and
the control unit is configured to
record, as the item of the occurrence period, the occurrence period of the abnormality included in the received abnormality notification.

10. A method for providing signal information performed by a roadside relay apparatus, the roadside relay apparatus including
a first communication unit to which a first line is connected,
a second communication unit to which a second line is connected,
a third communication unit to which a third line is connected, and
a communication processing unit configured to relay or intercept communication between the first communication unit and the second communication unit, the method comprising:
generating signal information for a vehicle, based on a control command, for controlling a traffic signal controller, received by the first communication unit and based on details of control, performed by the traffic signal controller, received by the second communication unit; and
outputting the generated signal information to the third communication unit,
the first line being a communication line for wired communication with a central apparatus of a traffic control system,
the second line being a communication line for wired communication with the traffic signal controller,
the third line being a communication line for wired communication with a communication apparatus that belongs to a communication system configured to wirelessly provide information to the vehicle.
